(19) United States
(12) Patent Application Publication
(10) Pub. No.: US 2008/0181650 A1
(43) Pub. Date: Jul. 31, 2008

(54) IMAGE FORMING APPARATUS AND CONTROL METHOD THEREOF

(75) Inventor: Makoto Matsui, Mishima-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/626,930

(22) Filed: Jan. 25, 2007

(51) Int. Cl. G03G 15/00

(52) U.S. Cl. 399/80

(57) ABSTRACT

An image forming apparatus of the invention has a connection port to which portable storage media (USB memories), each having stored therein a different kind of identification information, are connectable and a storage device (an HDD). The storage device (the HDD) includes a management table in which user information for specifying users allowed to use the image forming apparatus and permission information for specifying usable functions are stored. When the portable storage medium (the USB memory) is connected to the connection port by a user, the identification information stored therein is read out and the identification information is collated with the user information in the management table to perform authentication check for the user.

### BACKGROUND OF THE INVENTION

1. Field of the Invention

The present invention relates to an image forming apparatus such as an MFP (Multi-Function Peripherals), which is a digital complex machine, or a copying machine and a control method thereof. The image forming apparatus and the control method have a use restricting function.

2. Description of the Related Art

In general, among image forming apparatuses such as an MFP, a copying machine, and a printer, there are image forming apparatuses that have plural functions such as a copy function and a scan function. In such image forming apparatuses of a complex type, when same image data is copied on plural sheets or scanned, the image data is temporarily stored in a storage device such as an HDD, read out from this storage device, and outputted by a printer unit. In some cases, the MFP and a PC (Personal Computer) are connected via a network, image data created by the PC is printed by the MFP, and image data scanned and read by the MFP is transmitted to the PC.

In the image forming apparatus, since image data remains in the storage device such as an HDD, it is necessary to improve security from the viewpoint of confidentiality of the image data. Therefore, users allowed to use the image forming apparatus may be limited or functions usable by users may be limited. When users are limited or functions are limited, it is desirable to check the number of sheets used in a unit of department or a unit of individual and perform management to prevent the number of sheets used from exceeding an allowable number of sheets.

In JP-A-2005-125707, a number-of-prints managing apparatus is described. In this example, to limit the number of prints, storing means (e.g., a USB memory) having an authentication function is used. Print data is written in this storing means and this storing means is connected to a computer to carry out printing. Moreover, information on the number of prints is written in the storing means to manage the number of prints.

However, in this conventional technique, a special authentication function is necessary. Since print data is written in the storing means (the USB memory), a quantity of data in the storing means increases. When the storing means is lost, it is likely that the data is drained out to third parties.

The present invention provides an image forming apparatus and a control method thereof that realize improvement security and improvement operability.

### BRIEF DESCRIPTION OF THE DRAWINGS

FIG. 1 is a diagram for schematically explaining a structure of an image forming apparatus of the invention;

FIG. 2 is a block diagram showing a structure of an embodiment of the image forming apparatus of the invention;

FIG. 3 is an explanatory diagram showing data in a management table in the image forming apparatus of the invention;

FIG. 4 is a plan view showing an operation panel in the image forming apparatus of the invention;

FIG. 5 is a flowchart for explaining operations of the image forming apparatus of the invention;

FIG. 6 is an explanatory diagram showing an example of display on a display unit in the flowchart in FIG. 5;

FIG. 7 is a flowchart for explaining a procedure for updating a counter in the image forming apparatus of the invention;

FIGS. 8A and 8B are flowcharts for explaining a procedure of registration and change of the management table in the image forming apparatus of the invention;

FIGS. 9A and 9B are explanatory diagrams showing examples of display on the display unit at the time of registration and change of the management table; and

FIG. 10 is a flowchart for explaining a procedure of a network task in the image forming apparatus of the invention.

### DETAILED DESCRIPTION OF THE INVENTION

Throughout this description, the embodiment and example shown should be considered exemplars, rather than limitations on the apparatus and methods of the present invention.

An embodiment of the invention will be hereinafter explained in detail with reference to the drawings. In the respective figures, identical components are denoted by identical reference numerals and signs.

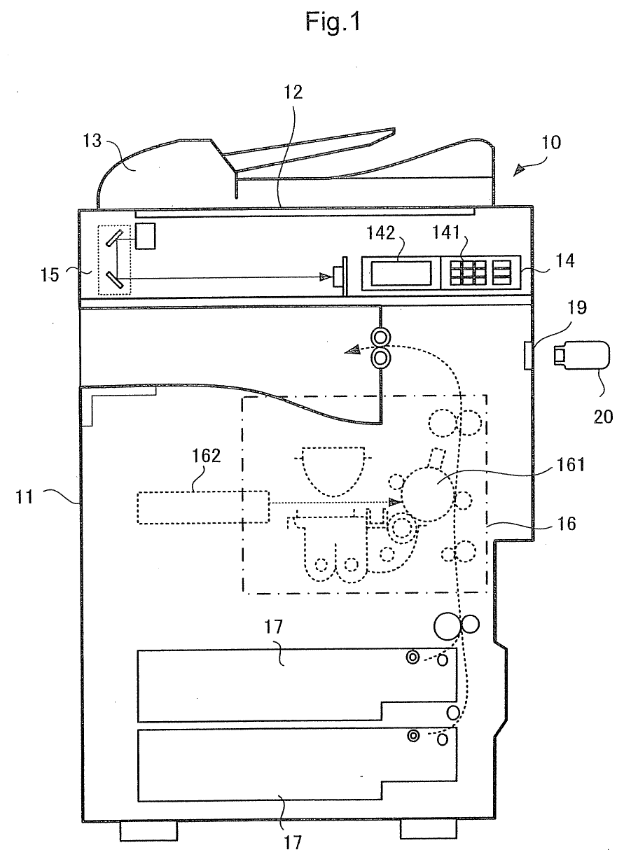

FIG. 1 is a diagram showing an embodiment of an image forming apparatus of the invention. In the following explanation, an MFP (Multi-Function Peripherals), which is a complex machine, is explained as an example. However, it is also possible to apply the invention to other image forming apparatuses such as a printer and a copying machine.

In FIG. 1, reference numeral 10 denotes an MFP (an image forming apparatus). An original stand 12 is provided in an upper part of a main body 11 of the MFP 10. An auto document feeder (ADF) 13 is provided on the original stand 12 to be opened and closed freely. An operation panel 14 is provided in the upper part of the main body 11. The operation panel 14 has an operation unit 141 including various keys and a display unit 142.

The main body 11 has a scanner 15 and a printer 16 in the inside thereof. Moreover, plural cassettes 17, in which sheets of various sizes are stored, are provided in a lower part of the main body 1. The scanner 15 scans an original fed by the ADF 13 or an original placed on the original stand 12. The printer 16 includes a photoconductive drum 161 and a laser 162. The printer 16 scans and exposes the surface of the photoconductive drum 161 with a laser beam from the laser 162 to form an electrostatic latent image on the photoconductive drum 161.

A charging device, a developing device, a transfer device, and the like are arranged around the photoconductive drum 161. The electrostatic latent image on the photoconductive drum 161 is developed by the developing device and a toner image is formed on the photoconductive drum 161. The toner image is transferred onto a sheet by the transfer device. A structure of the printer 16 is not limited to the example shown in the figure. There are various systems as the structure of the printer 16.

A USB port 19 is provided on a side of the main body 11. USB is an abbreviation of Universal Serial Bus. A USB memory 20, which is a portable storage medium, is detachably attachable to the USB port 19. The USB memory 20 is a memory for specifying a user allowed to use the MFP 10. When a user connects the USB memory 20 to the USB port 19, the user is allowed to use the MFP 10.

The USB memory 20 includes a ROM. A vendor ID and a serial number are stored in the ROM as identification information of the USB memory 20. It is possible to uniquely identify the individual USB memory 20 by specifying the vendor ID and the serial numbers. Since such identification information is stored in the USB memory 20, the identification information is referred to as USB information in the following explanation.

As functions processed by the MFP 10, there are, for example, a copy function, a printer function, a scan function, and a network print function.

As the copy function, there are functions of monochrome copy and color copy. The printer function is a function of printing image data. The scan function is a function of copying image data scanned by the scanner 15. The network print function is a function of printing image data, which is sent from an external apparatus such as a PC (Personal Computer) to the main body 11, on the main body 11 side.

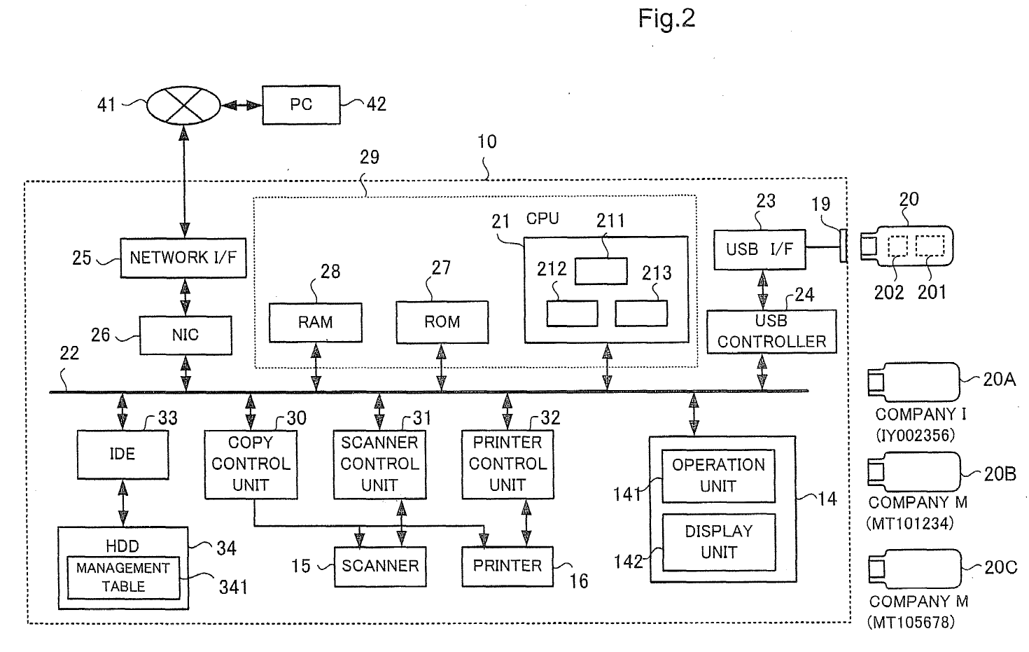

FIG. 2 is a block diagram showing a structure of the MFP 10. The MFP 10 is provided with a CPU 21. The CPU 21 includes a control unit 211, a registering unit 212, and an authenticating unit 213 and is connected to a PCI bus 22. The PCI bus is an abbreviation of Peripheral Component Interconnect Bus. The MFP 10 is further provided with a USB interface 23 and a network interface 25. The USB interface 23 is connected to the PCI bus 22 via a USB controller 24. The network interface 25 is connected to the PCI bus 22 via an NIC (Network Interface Card) 26.

The USB memory 20 is connectable to the MFP 10 via the USB interface 23. When the USB memory 20 is connected, the USB controller 24 reads USB information from the USB memory 20 and supplies the information read to the CPU 21. The network interface 25 includes a LAN board and a FAX modem and is connected to an external apparatus, for example, a PC 42 via an external communication line (LAN) 41. The NIC 26 controls transmission and reception of data to and from the external apparatus via the network interface 25.

A ROM 27 and a RAM 28 are connected to the PCI bus 22. The ROM 27 and the RAM 28 constitute a main control unit 29 in conjunction with the CPU 21. Various control programs necessary for operations of the main body 11 are stored in the ROM 27. The RAM 28 stores various data.

A copy control unit 30, a scanner control unit 31, a printer control unit 32, and an operation panel 14 are further connected to the PCI bus 22. Moreover, an HDD 34, which is a storage device, is connected to the PCI bus 22 via an IDE 33. The IDE 33 is an interface for connecting the HDD 34 to the PCI bus 22 and is an abbreviation of Integrated Device Electronics.

The copy control unit 30 controls a normal copy function that uses the scanner 15 and the printer 16. The scanner control unit 31 controls a scan function that uses the scanner 15 and a file function for storing scanned image data in the PC 42.

The printer control unit 32 controls a print function or a network print function that use the printer 16. Image data in performing print processing in the printer 16 is stored in the HDD 34. After the print processing is finished, the image data is erased from the HDD 34 according to overwrite processing.

The HDD 34 has a management table 341. User information for specifying a user allowed to use the MFP 10, permission information for specifying usable functions, and the like are stored in the management table 341.

The USB memory 20 has a ROM 201. In the ROM 201, USB information is stored as described above. A USB interface 202 that transmits data in the ROM 201 to the USB port 19 is built in the USB memory 20.

The USB memory 20 is carried by a user who uses the MFP 10. In the explanation of the example in FIG. 2, USB memories 20A, 20B, and 20C are used by different users, respectively.

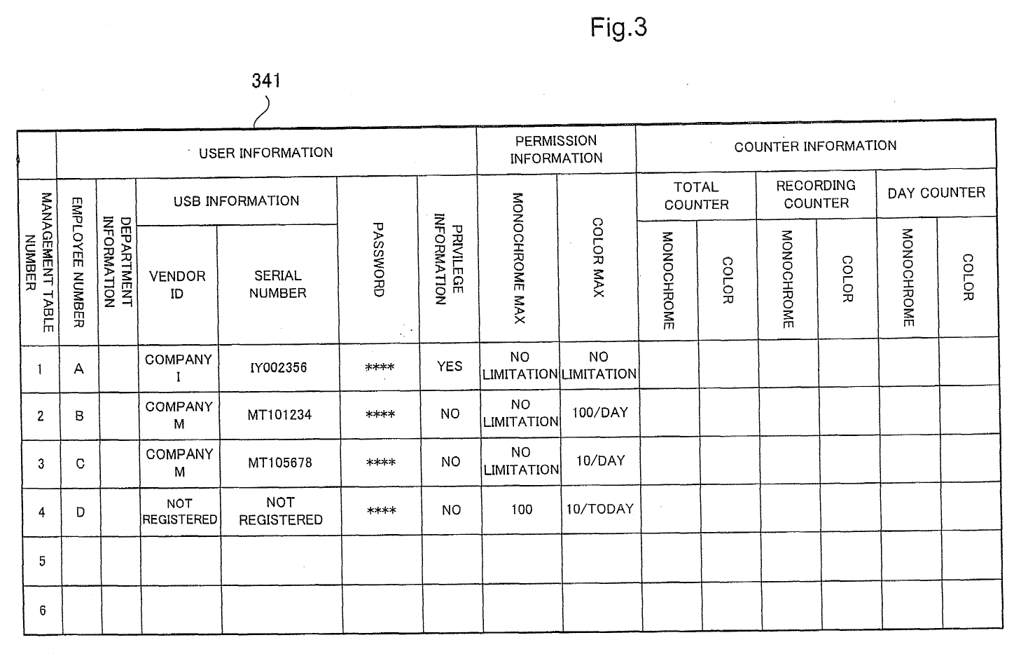

FIG. 3 shows a list of data in the management table 341. FIG. 3 includes a management table number, user information, permission information, and counter information. The management table number is a serial number in the case in which there are plural USB memories 20. The user information includes an employee number, department information, a vendor ID, a serial number, a password, and privilege information. A production ID may be added other than the vendor ID.

In the user information, the vendor ID and the serial number are information same as the USB information stored in the USB memory 20. In the embodiment, the USB memory 20A is held by a user A of an I company and the USB memories 20B and 20C are held by users B and C of an M company. The password is set for each of users A, B, and C. The privilege information represents whether an administrator is capable of rewriting contents of the management table 341. Users are divided into users having a privilege and users not having the privilege.

The permission information indicates functions of the MFP 10 that the users are permitted to use. In the embodiment, allowable numbers of sheets for monochrome printing and color printing are shown, respectively. An allowable number of sheets per one day may be set. An allowable number of sheets on days of use may be set.

The counter information includes a total counter, a recording counter, and a day counter. The total counter indicates a total number of sheets used for each user, the recording counter indicates the number of sheets used in an allowable number of sheets for each user, and the day counter indicates the number of sheets used for one day of days of use.

The CPU 21 includes a control unit 211, a registering unit 212, and an authenticating unit 213. In registering the user information, the permission information, and the counter information in the management table 341, the user performs registration processing with the registering unit 212. As execution of such registration processing, the user operates the operation unit 141 of the operation panel 14 and inputs the information while looking at display of the display unit 142.

When the USB memory 20 is inserted in the USB port 19, the authenticating unit 213 performs authentication check on the basis of the USB information. When the USB memory 20 is inserted, the control unit 211 permits use of predetermined functions on the basis of an authentication result. When the use of the functions is prohibited, the control unit 211 displays an indication to that effect on the display unit 142.

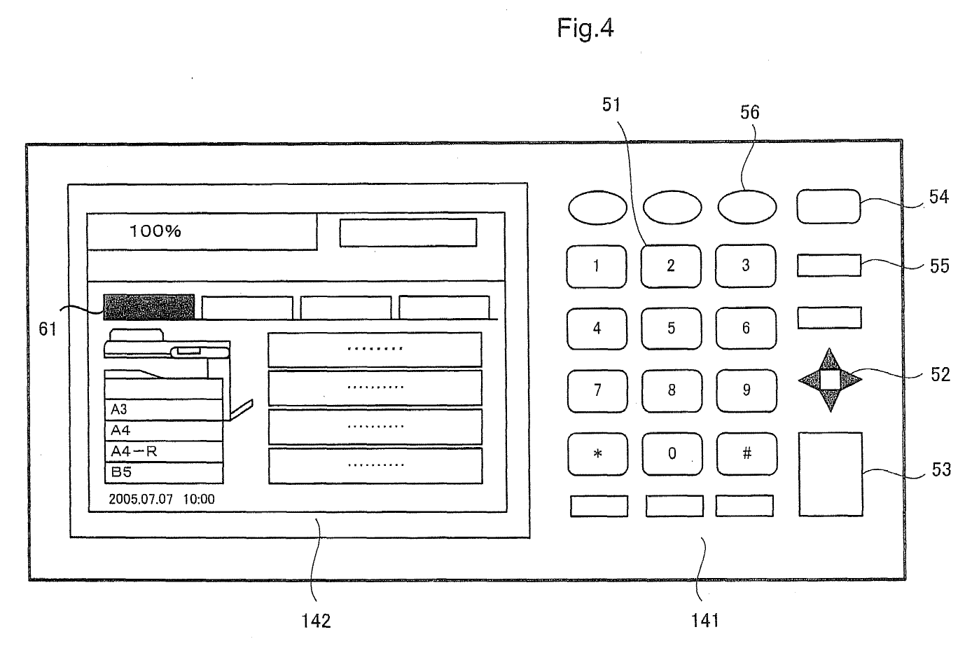

FIG. 4 shows an example of the operation panel 14. In FIG. 4, reference numeral 141 denotes an operation unit. The operation unit 141 has a ten key 51, a cursor key 52, an enter key 53, a registration key 54, a cancel key 55, a logoff key 56, and the like.

Reference numeral 142 denotes a display unit. The display unit 142 has a function of a touch panel. As a display screen of the display unit 142, it is possible to display various mode screens other than a basic screen by selecting an index button 61.

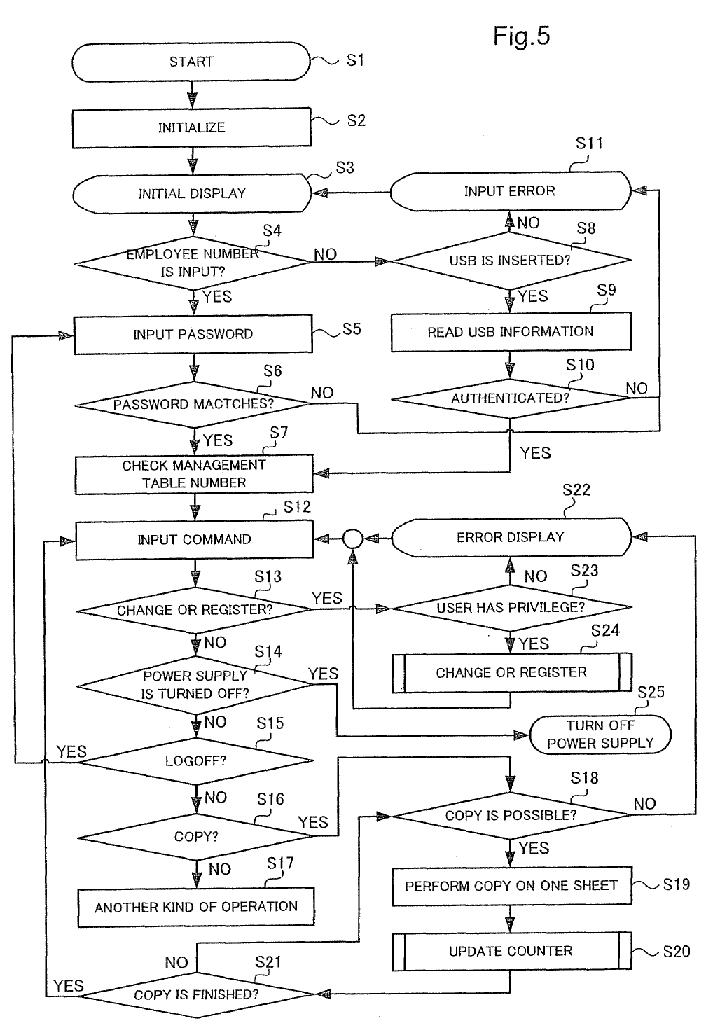

Operations of the image forming apparatus of the invention will be explained with reference to FIG. 5.

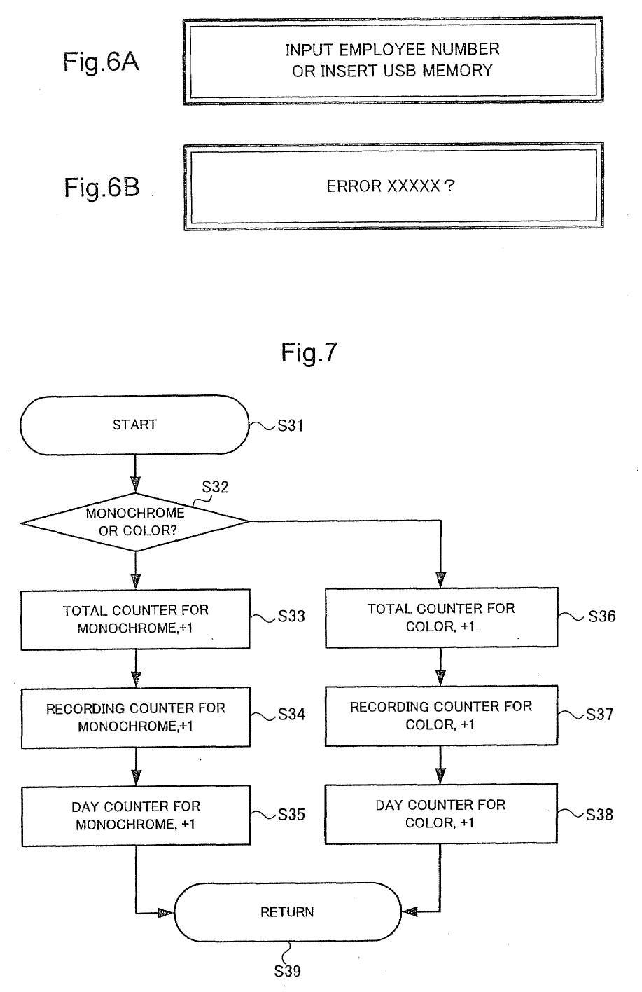

In FIG. 5, when a user turns on a power supply in start step S1, in step S2, the image forming apparatus performs initialization processing and starts a network task in the initialization processing. In step S3, the image forming apparatus performs initial display on the display unit 142 to display a message for urging the user to input an employee number or insert the USB memory 20. The initial display is performed as shown in FIG. 6A.

When an employee number is inputted in step S4, in step S5, the image forming apparatus urges the user to input a password. When a password is inputted, in step S6, the image forming apparatus determines whether there is a combination of an employee number and a password matching the password inputted with reference to the management table 341 of the HDD 34. When there is a combination matching the password inputted, the image forming apparatus allows the user to use the image forming apparatus. When the user is allowed to use the image forming apparatus, in step S7, the image forming apparatus checks a management table number.

On the other hand, when an employee number is not inputted in step S4 and the USB memory 20 is inserted in step S8, the image forming apparatus proceeds to step S9. In step S9, the image forming apparatus reads out USB information (a vendor ID and a serial number) stored in the USB memory 20 by the USB controller 24.

In step S10, the image forming apparatus performs, on the basis of the USB information read out, authentication to find whether there is information matching the USB information in the management table 341 of the HDD 34. When the USB information is authenticated, the image forming apparatus allows the user to use the image forming apparatus. In step S7, the image forming apparatus checks a management table number.

When the USB memory 20 is not inserted in step S8, when the USB information is not authenticated in step S10, and when the password does not match the combination in step S6, the image forming apparatus shifts to step S11. The image forming apparatus performs error display on the display unit 142 and returns to step S3. FIG. 6B shows an example of the error display.

When the check of the management table number is finished in step S7 and the user inputs a command in step S12, the image forming apparatus proceeds to the following steps according to contents of the command.

Step S13 is a step in changing contents registered in the management table 341 or newly registering the contents. The image forming apparatus determines whether registration operation is performed. In step S14, the image forming apparatus determines whether operation for turning off the power supply is performed. In step S15, the image forming apparatus determines whether operation for logoff is performed. In step S16, the image forming apparatus determines whether operation for copy is performed.

For example, when the operation for copy is performed in step S12, since all the determinations in steps S13, S14, and S15 are NO, the image forming apparatus proceeds to step S16. When it is determined in step S16 that the copy operation is performed, in step S18, the image forming apparatus determines sheet by sheet whether copy on the sheet is possible.

In other words, it is determined whether copy is performed within an allowable number of sheets on the basis of permission information in the management table 341. When copy is possible, the copy is performed on one sheet in step S19. In step S20, counter information in the management table is updated. For example, when monochrome printing is performed, an accumulated number of sheets of monochrome copy is incremented by one and the accumulated number of sheets is updated.

When the copy on one sheet is finished, in the next step S21, the image forming apparatus determines whether the copy is finished. When the copy is continued, the counter information is updated through steps S18 to S21. When it is determined in step S21 that the copy is finished, the image forming apparatus returns to step S12 and waits for a new command. In this way, the counter information is updated according to the number of copies. The counter information is information at the time when the user uses the MFP 10 (use information) and is updated according to a state of use.

When the number of copies exceeds the allowable number of sheets, the image forming apparatus proceeds from step S18 to step S22 and displays an indication that the number of usable sheets is limited on the display unit 142. When it is determined in step S16 that the copy operation is not performed, the image forming apparatus proceeds to step S17 and another kind of operation is executed.

When it is determined in step S14 that the operation for turning off the power supply is performed, in step S25, the image forming apparatus performs processing for turning off the power supply. When it is determined in step S15 that the operation for logoff is performed, the image forming apparatus returns to step S5 and disallows other users to use the image forming apparatus until the users input passwords.

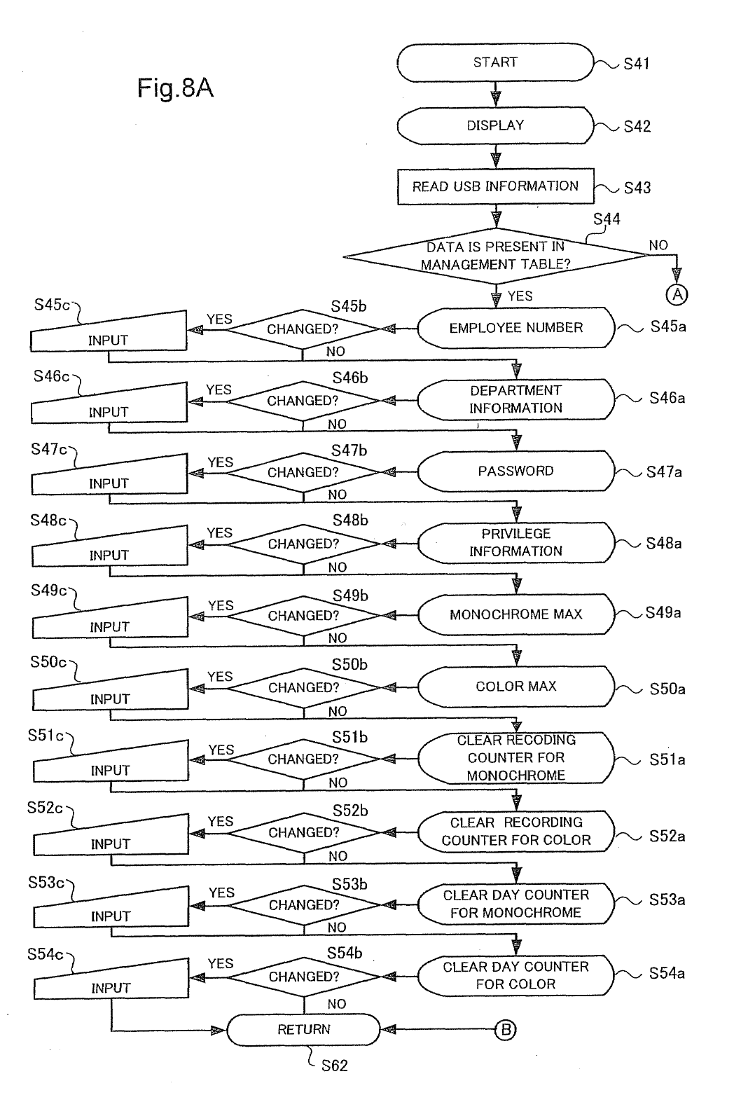

FIG. 7 is a flowchart showing a procedure for updating counter information in step S20 in FIG. 5. The image forming apparatus updates the total counter, the recording counter, and the day counter according to the type of monochrome or color.

Step S31 is a start step of counter update. In the next step S32, it is determined whether copy is monochrome copy or color copy. In the case of the monochrome copy, the image forming apparatus proceeds to steps S33, S34, and S35 in order and values of the number of sheet of the total counter is incremented by one, the recording counter, and the day counter for the monochrome copy, respectively.

When it is determined in step S32 that the copy is the color copy, the image forming apparatus proceeds to steps S36, S37, and S38 in order and values of the number of sheet of the total counter is incremented by one, the recording counter, and the day counter for the color copy, respectively. Step S39 is a return step. The image forming apparatus returns to step S32 and performs, in the same manner, update of the counters for one sheet subjected to copy processing anew.

In this way, when the user holding the USB memory 20 uses the MFP 10, the number of sheets used is recorded in the management table 341 for each user. Since the number of sheets is recorded separately for monochrome printing and color printing, the administrator who manages the MFP 10 is capable of carefully managing a state of use of the MFP 10.

On the other hand, when the registration key is operated in the command input in step S12 in FIG. 5, the image forming apparatus determines that operation for registration is performed in step S13, shifts to step S23, and determines whether the user is a user having the privilege.

When the user has the privilege, in step S24, the image forming apparatus performs registration processing. When the user does not have the privilege, the image forming apparatus proceeds to step S22 and performs error display. After steps S22 and S24, the image forming apparatus returns to step S12 and waits for a new command.

In the registration processing in step S24, when the user presses the registration key 54 shown in FIG. 4, the image forming apparatus enters a registration mode and becomes capable of performing a change of the management table and processing for new registration. In the case of the new registration, a new USB memory 20 is prepared.

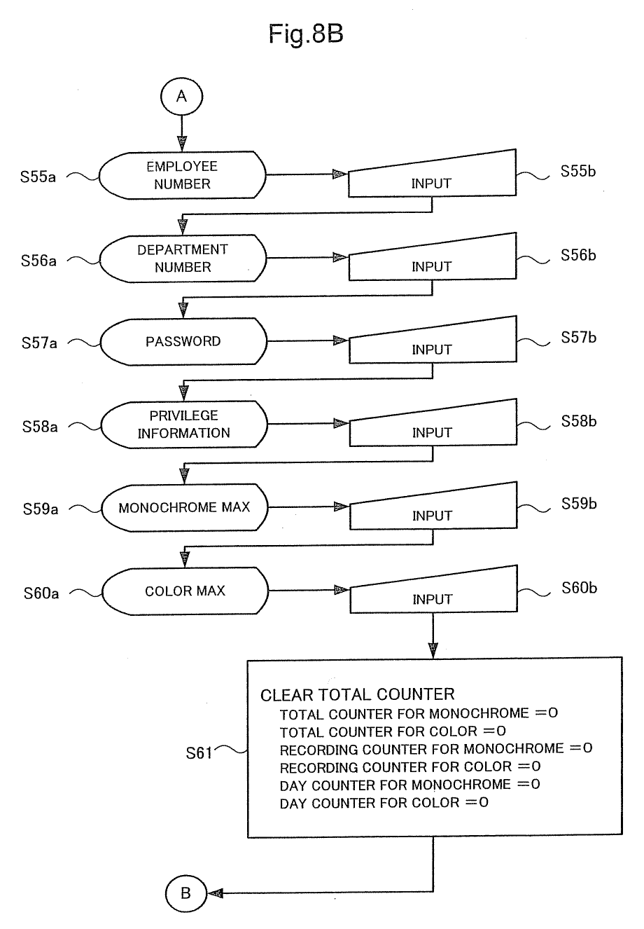

FIG. 8A is a flowchart showing a procedure of operation for changing the management table. In FIG. 8A, step S41 is a start step. In the next step S42, a message for urging the user to insert the USB memory 20 is displayed on the display unit 142.

When the user inserts the USB memory 20 that the user wishes to register anew or change, in step S43, the image forming apparatus reads USB information (a vendor ID and a serial number) from the USB memory 20. In step S44, the image forming apparatus compares the USB information with data in the management table 341.

When there is data in the management table 341 in step S44, the image forming apparatus determines that change processing is performed and proceeds to step S45a. When there is no data in the management table 341, the image forming apparatus determines that new registration is performed and proceeds to step S55a in FIG. 8B.

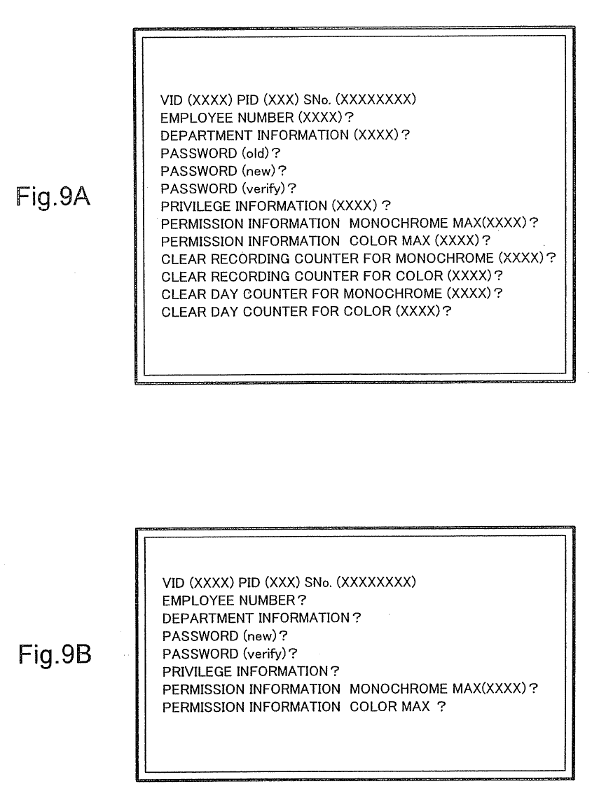

In the case of the change processing, items in FIG. 9A are displayed on the display unit 142 in FIG. 4. The user selects an item, which the user wishes to change, using the cursor key 52, determines the item selected using the enter key 53, and inputs contents of change using the ten key 51 and the like.

In FIG. 8A, for example, in changing an employee number, in step S45a, the user selects the item of an employee number. In step S45b, the image forming apparatus determines whether the enter key 53 is operated. When the enter key 53 is operated, the image forming apparatus determines that the change processing is performed and proceeds to step S45c. The user inputs an employee number after the change and presses the enter key 53.

When the enter key 53 is not operated in step S45b and after contents of change is inputted and the enter key 53 is pressed in step S45c, the image forming apparatus proceeds to the next step S46a. Steps S46a to S46c are steps for changing department information, S47a to S47c are steps for changing a password, and S48a to 48c are steps for changing privilege information.

The next steps S49a to S49c are steps for changing an allowable number of sheets of monochrome printing in the permission information and S50a to S50c are steps for changing an allowable number of sheets of color printing.

The next steps S51a to S51c are steps for clearing the number of sheets of monochrome printing of the recording counter in the counter information, inputting the number of sheets after change, and changing data of the recording counter. Similarly, S52a to S52c are steps for clearing the number of sheets of color printing of the recording counter and changing data in the recording counter, S53a to S53c are steps of clearing the number of sheet of monochrome printing of the day counter and changing data of the day counter, and S54a to S54c are steps for clearing the number of sheets of color printing of the day counter and changing data in the day counter.

In this way, users having the privilege are capable of arbitrarily rewriting data in the management table.

On the other hand, when it is determined in step S44 that new registration is performed, the image forming apparatus proceeds to step S55a in FIG. 8B. In the case of new registration, items in FIG. 9B are displayed on the display unit 142, the user sequentially selects items to be registered anew using the cursor key 52 and inputs contents of registration using the ten key 51 and the like.

The user selects the item of an employee number in steps 55a and inputs and registers an employee number in step 55b. Similarly, the user inputs department information in S56a and S56b, inputs a password in S57a and S57b, inputs privilege information in S58a and S58b, inputs an allowable number of sheets of monochrome printing in the permission information in S59a and S59b, and inputs an allowable number of sheets of color printing in S60a and S60b.

Moreover, step S61 is a step of clearing counter information. The image forming apparatus clears the total counter, the recording counter, and the day counter for each of monochrome printing and color printing and sets the counters to zero.

When the change processing and the new registration are finished in this way, the image forming apparatus shifts to step S62 in FIG. 8A. Step S62 is a return step. The image forming apparatus returns to step S42 and waits for change processing and new registration anew.

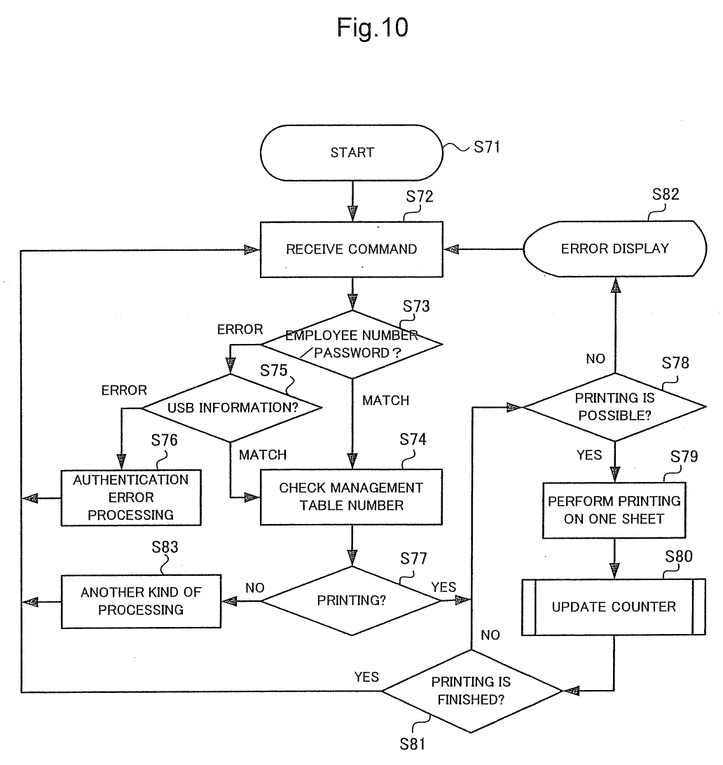

FIG. 10 is a flowchart showing operations in executing a command from the PC 42 via the network 41. In operating the MFP 10 according to a command from the PC 42, the user inputs an employee number and a password via the PC 42. Alternatively, a slot in which the USB memory 20 is insertable is provided in the PC 42 and the user inserts the USB memory 20 in the slot. The image forming apparatus reads a vendor ID and a serial number, determines whether the vendor ID and the serial number are registered in the management table 341, and executes a command for printing or the like.

In FIG. 10, step S71 is a start step of a network task. In step S72, the image forming apparatus receives a command from the PC 42. In the next step S73, the image forming apparatus determines whether an employee number and a password are inputted. When an employee number and a password are inputted, the image forming apparatus performs authentication with reference to the management table 341. When there are an employee number and a password matching a combination of the employee number and the password inputted, in step S74, the image forming apparatus checks a management table number.

On the other hand, when an employee number and a password are not inputted in step S73 or when the employee number and the password inputted are wrong, the image forming apparatus shifts to step S75. In step S75, the image forming apparatus reads out USB information (a vendor ID and a serial number) stored in the USB memory 20 and performs, on the basis of the USB information read out, authentication to find whether there is information matching the USB information in the HDD management table 341. When the USB information is authenticated, the image forming apparatus allows the user to use the image forming apparatus. In step S74, the image forming apparatus checks a management table number.

When it is determined in step S75 that the USB memory 20 is not inserted or when the user is not authenticated, the image forming apparatus shifts to step S76, performs processing for an authentication error, performs error display on, for example, the PC 42, and returns to step S72.

When the check of the management table number is finished in step S74, in step S77, it is determined whether operation for printing is performed. When the print operation is performed, in step S78, the image forming apparatus determines sheet by sheet whether printing on the sheet is possible. When printing is possible, in step S79, printing is performed on one sheet. In step S80, counter information in the management table is updated. For example when monochrome printing is performed, an accumulated number of sheet of monochrome printing is incremented by one to that point and the counter information is updated.

When the printing on one sheet is finished, in the next step S81, the image forming apparatus determines whether the printing is finished. When the printing is continued, the counter information is updated through steps S78 to S81. When it is determined in step S81 that the printing is finished, the image forming apparatus returns to step S72 and waits for a new command.

When the number of prints exceeds the allowable number of sheets during the printing, the image forming apparatus proceeds from step S78 to step S82 and performs error display indicating that print is impossible.

When it is determined in step S77 that the print operation is not performed, the image forming apparatus proceeds to step S83. Other kinds of processing corresponding to operation contents are executed.

In this way, in the image forming apparatus of the invention, since the USB memory 20 is used instead of the counter used when copy or printing is executed, it is possible to perform management in a unit of individual from management in a unit of department and perform management more strictly.

In the embodiment of the invention, the example in which the number of prints in the print function is managed as a management of the counter is described. However, the number of scanned originals in the scanner function may be managed. When the image forming apparatus has a facsimile function connected to a telephone line, the number of originals transmitted may be managed.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus having plural functions comprising:
a connection port that is provided in the image forming apparatus and to which portable storage media, each having stored therein a different kind of identification information, are connectable;
a storage device including a management table in which user information for specifying users allowed to use the image forming apparatus and permission information for specifying usable functions are stored;
an authenticating unit configured to read out the identification information from the storage medium, when the storage medium is connected to the connection port by a user, and perform authentication check for the user with reference to the user information in the management table; and
a control unit configured to permit the user to use a function permitted in advance in accordance with the permission information, when the user is authenticated by the authenticating unit, and store in the management table, use information updated according to a state of use of the function permitted.

2. An image forming apparatus according to claim 1, wherein the image forming apparatus is a printer.

3. An image forming apparatus according to claim 2, wherein
the storage device is constituted by an HDD, and
the HDD includes a storing unit capable of storing image data subjected to print processing by the printer and the management table.

4. An image forming apparatus according to claim 1, wherein the portable storage medium is a USB memory.

5. An image forming apparatus according to claim 1, wherein the user information stored in the management table includes information same as the identification information stored in the portable storage medium.

6. An image forming apparatus according to claim 1, wherein the user information includes information indicating a privileged person, who is capable of rewriting the information stored in the management table, to make at least one kind of information of the user information, the permission information, and the use information changeable or registrable by the privileged person.

7. An image forming apparatus according to claim 1, wherein the user information includes department information indicating departments to which users belong and information on the individual users to make it possible to store the use information in the management table for each of the departments or for each of the individuals.

8. An image forming apparatus according to claim 2, wherein the permission information stored in the management table includes information indicating a number of sheets processable by the printer.

9. An image forming apparatus according to claim 8, wherein the control unit prohibits processing exceeding the number of sheets defined in the permission information and performs error display on a display unit.

10. An image forming apparatus according to claim 2, wherein the use information stored in the management table is information indicating a number of sheets used for each user processed by the printer.

11. An image forming apparatus having plural functions comprising:
a network interface for connecting the image forming apparatus to an external apparatus via a network;
a connection port that is provided in the image forming apparatus or the external apparatus and to which portable storage, each having stored therein a different kind of identification information, are connectable;
a storage device including a management table in which user information for specifying users allowed to use the image forming apparatus and permission information for specifying usable functions are stored;
an authenticating unit configured to read out the identification information from the storage medium, when the storage medium is connected to the connection port by a user, and perform authentication check for the user with reference to the user information in the management table; and
a control unit configured to permit the user to use a function permitted in advance in accordance with the permission information, when the user is authenticated by the authenticating unit, and store in the management table, use information updated according to a state of use of the function permitted.

12. An image forming apparatus according to claim 11, wherein the image forming apparatus is a printer.

13. An image forming apparatus according to claim 11, wherein
the storage device is constituted by an HDD, and
the HDD includes a storing unit capable of storing image data sent from the external apparatus via the network or image data created by a main body of the image forming apparatus and the management table.

14. An image forming apparatus according to claim 11, wherein the portable storage medium is a USB memory.

15. A control method of an image forming apparatus having plural functions, portable storage media, each having stored therein a different kind of identification information, being connectable to the image forming apparatus,
the control method comprising:
storing, in a management table, user information for specifying users allowed to use the image forming apparatus and permission information for specifying usable functions, the management table being included in a storage device provided in the image forming apparatus;
reading out the identification information from the storage medium, when the storage medium is connected to the connection port by a user, and performing authentication check for the user with reference to the user information in the management table;
permitting the user to use functions permitted in advance in accordance with the permission information, when the user is authenticated by the authenticating unit; and
storing, in the management table, use information updated according to a state of use of the functions permitted.

16. An image forming apparatus according to claim 15, wherein the image forming apparatus is a printer.

17. A control method of an image forming apparatus according to claim 16, wherein information indicating a number of sheets processable by the printer is stored in the management table as the permission information.

18. A control method of an image forming apparatus according to claim 16, wherein
information indicating a number of sheets processable by the printer is stored in the management table as the permission information, and
execution of processing exceeding the processable number of sheets is prohibited.

19. A control method of an image forming apparatus according to claim 16, wherein information indicating a number of sheets used for each user processed by the printer is stored in the management table as the use information.

20. An image forming apparatus according to claim 15, wherein information indicating a privileged person, who is capable of rewriting the information stored in the management table, is included in the user information to make at least one kind of information of the user information, the permission information, and the use information changeable or registrable by the privileged person.
